(19) United States
(12) Patent Application Publication
(10) Pub. No.: US 2022/0291521 A1
(43) Pub. Date: Sep. 15, 2022

(54) LIGHT GUIDE, ILLUMINATOR, AND STEREOSCOPIC DISPLAY

(71) Applicant: OMRON Corporation, Kyoto-shi (JP)

(72) Inventors: Masayuki SHINOHARA, Kyoto-shi (JP); Gouo KURATA, Kyoto-shi (JP); Yasuhiro TANOUE, Kyoto-shi (JP); Masafumi DANNO, Kyoto-shi (JP); Yuto MORI, Kyoto-shi (JP)

(73) Assignee: OMRON Corporation, Kyoto-shi (JP)

(21) Appl. No.: 17/673,846

(22) Filed: Feb. 17, 2022

(30) Foreign Application Priority Data
Mar. 12, 2021 (JP) 2021-40839

(51) Int. Cl. G02B 30/33; F21V 8/00

(52) U.S. Cl. CPC G02B 30/33; G02B 6/0036; G02B 6/0045

(57) ABSTRACT

A light guide according to one or more embodiments may include an incident surface that receives light from a light source, a first reflective surface that reflects incident light, a second reflective surface that reflects light reflected by the first reflection surface to be parallel light, and an emission surface that may allow parallel light reflected by the second reflective surface to be emitted. The first reflective surface reflects light at a reflection angle nonuniform across the first reflective surface. The second reflective surface has a saw-toothed cross section.

### CROSS-REFERENCE TO RELATED APPLICATION

This application claims priority to Japanese Patent Application No. 2021-040839 filed on Mar. 12, 2021, the contents of which are incorporated herein by reference.

### FIELD

The present disclosure relates to a light guide for emitting parallel light, an illuminator including the light guide, and a stereoscopic display including the illuminator.

### BACKGROUND

A related stereoscopic display displays a three-dimensional image for viewing without glasses. Such a stereoscopic display includes a light guide plate, an illuminator located at an end of the light guide plate to emit light to the light guide plate, a left-eye display pattern including multiple first prisms on the rear surface of the light guide plate, and a right-eye display pattern including multiple second prisms on the rear surface of the light guide plate. In the above described structure, the multiple first prisms and the multiple second prisms reflect light from the illuminator to display a left-eye image and a right-eye image above the front surface of the light guide plate, allowing an observer to view a stereoscopic image.

As described above, to display a larger stereoscopic image, the stereoscopic display uses the illuminator to emit parallel light toward the light guide plate. Such an illuminator to emit parallel light is described in, for example, Patent Literature 1.

The illuminator described in Patent Literature 1 includes a light guide having an incident surface to receive light from a light source, a first reflective surface, a second reflective surface, and an emission surface. The first reflective surface totally internally reflects at least a portion of light incident on the incident surface. The second reflective surface totally internally reflects at least a portion of light totally internally reflected by the first reflective surface to be parallel light. The emission surface allows parallel light totally internally reflected by the second reflective surface to be emitted.

### CITATION LIST

### Patent Literature

Patent Literature 1: Japanese Patent No. 6720809

### SUMMARY

The light guide described in Patent Literature 1 cannot have a wider emission surface. A wider stereoscopic display may include an illuminator having a larger light guide or may include an array of many light guides.

One or more embodiments are directed to a light guide having a larger emission surface (emission area) and a shorter length perpendicular to the emission surface (vertical length) than related light guides.

One or more embodiments may have structures described below.

A light guide according to one or more embodiments may include an incident surface that receives light from a light source, a first deflection surface that deflects light incident on the incident surface, and a second deflection surface that deflects at least a portion of light deflected by the first deflection surface to be parallel light. The first deflection surface deflects light incident on the incident surface at a deflection angle nonuniform across the first deflection surface. The second deflection surface has a saw-toothed cross section.

The above structure having the first deflection surface with a nonuniform deflection angle at which light incident on the incident surface is deflected may deflect the light to spread over the second deflection surface larger than the first deflection surface, which may allow the light guide to have a larger emission surface (longer lateral length). The saw-toothed second deflection surface shortens the length perpendicular to the emission surface (vertical length) of the light guide.

In a light guide according to one or more embodiments, the first deflection surface is curved, and the deflection angle varies continuously from a first end to a second end of the first deflection surface.

The above structure may allow more uniform intensity distribution of light emitted through the emission surface.

In a light guide according to one or more embodiments, the first deflection surface has a degree of variation in the deflection angle varying from the first end to the second end.

The above structure may control the intensity distribution of light emitted through the emission surface to be uniform.

In a light guide according one or more embodiments, the second deflection surface includes a first point and a second point. The first point is an intersection between the second deflection surface and an optical path of light incident on the incident surface, deflected by the first deflection surface, and reaching the second deflection surface. The second point is an intersection between the second deflection surface and an optical path of light incident on the incident surface, deflected by the first deflection surface, and reaching the second deflection surface. The optical path of light from the incident surface to the first point is shorter than the optical path of light from the incident surface to the second point. θ1×L1<θ2×L2, where L1 is a length of the optical path of light from the incident surface to the first point, L2 is a length of the optical path of light from the incident surface to the second point, θ1 is a visual angle of an emission area in the incident surface when the first deflection surface is viewed along the optical path from the first point, and θ2 is a visual angle of the cross section when the first deflection surface is viewed from the second point.

The above structure may improve uniformity in the intensity distribution of light emitted through the emission surface.

In a light guide according to one or more embodiments, a value of an expression θ×L increases with an increase in the length of the optical path of the light from the incident surface to a point on the second deflection surface, where θ is a visual angle of the emission area when the first deflection surface is viewed from the point on the second deflection surface, and L is a length of the optical path from the incident surface to the point.

The above structure may further improve uniformity in the intensity distribution of light emitted through the emission surface.

In a light guide according to one or more embodiments, the first deflection surface deflects light incident on the incident surface to allow θA to be substantially uniform at a point on the second deflection surface, where θA is a visual angle of an emission area in the incident surface when the first deflection surface is viewed from the second deflection surface.

The above structure may allow substantially uniform intensity distribution of light emitted through the emission surface.

In a light guide according to one or more embodiments, the first deflection surface includes a third point located in a direction aligned with an optical axis of light incident on the incident surface when viewed from an emission area in the incident surface, and a fourth point located in a direction tilted with respect to the optical axis when viewed from the emission area. The first deflection surface has a greater curvature at the fourth point than at the third point.

The above structure may allow more uniform intensity distribution of light emitted through the emission surface.

In a light guide according to one or more embodiments, the first deflection surface reflects light incident on the incident surface. The deflection angle may be a reflection angle at which light incident on the incident surface is reflected by the first deflection surface.

In a light guide according to one or more embodiments, the first deflection surface totally internally reflects at least a portion of light incident on the incident surface.

The above structure may allow light to be totally internally reflected and thus eliminates a reflective member such as metal deposited onto the first deflection surface. Accordingly, the material cost and the production cost of the light guide may be reduced.

In a light guide according to one or more embodiments, the second deflection surface may reflect at least a portion of light deflected by the first deflection surface to be parallel light.

In a light guide according to one or more embodiments, the second deflection surface totally internally reflects at least a portion of light deflected by the first deflection surface to be parallel light.

The above structure may allow light to be totally internally reflected and thus eliminates a reflective member such as metal deposited onto the second deflection surface. Accordingly, the material cost and the production cost of the light guide may be reduced.

An illuminator according to one or more embodiments includes the above described light guide and the light source. The above described structure may allow the illuminator to be compact. Additionally, the light guide having the larger emission surface may allow the illuminator to include a smaller number of the light guides than a known illuminator, thus reducing the production cost of the illuminator.

A stereoscopic display according to one or more embodiments includes the above illuminator, and a light guide plate that receives parallel light emitted through the second deflection surface and forms a stereoscopic image in a space as a real image or a virtual image. The above structure may allow the stereoscopic display to be compact.

A stereoscopic display according to one or more embodiments includes the above illuminator, and a light guide plate integral with the light guide to receive parallel light emitted through the second deflection surface and form a stereoscopic image in a space as a real image or a virtual image.

A light guide according to one or more embodiments may include a larger emission surface (emission area) and a shorter length perpendicular to the emission surface (vertical length) than known light guides.

### BRIEF DESCRIPTION OF THE DRAWINGS

FIG. 1 is a diagram illustrating a perspective view of a stereoscopic display according to a first embodiment or embodiments.

FIG. 2 is a diagram illustrating a perspective view of an illuminator according to a first embodiment or embodiments.

FIG. 3 is a diagram illustrating a cross-sectional view of a light guide according to a first embodiment or embodiments.

FIG. 4 is a diagram illustrating a cross-sectional view of a light guide according to a first embodiment or embodiments.

FIG. 5 is a diagram illustrating an enlarged view of region R in FIG. 3.

FIG. 6 is a diagram illustrating a perspective view of a light guide according to a second embodiment or embodiments.

FIG. 7 is a schematic diagram illustrating a light guide according to a second embodiment or embodiments and a light guide according to a modification, each showing a portion near an incident surface.

FIG. 8 is a diagram illustrating a perspective view of a light guide according to a third embodiment or embodiments.

### DETAILED DESCRIPTION

One or more embodiments will now be described with reference to the drawings. One or more embodiments described below are mere examples in any aspect. One or more embodiments may be variously modified or altered without departing from the scope of the invention. More specifically, one or more embodiments may be implemented as appropriate using the configuration specific to each embodiment.

### First Embodiment

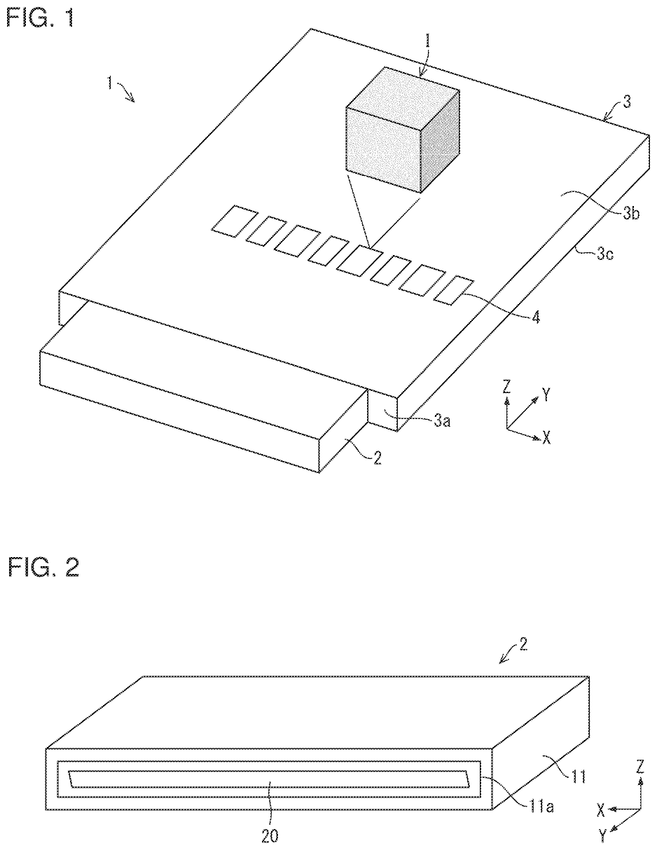

A stereoscopic display 1 according to one or more embodiments will first be described with reference to FIG. 1. FIG. 1 is a perspective view of the stereoscopic display 1.

As shown in FIG. 1, the stereoscopic display 1 includes an illuminator 2, a light guide plate 3, and an optical path deflector 4.

The illuminator 2 emits light (hereafter, also referred to as parallel light), to the light guide plate 3, parallel to a direction perpendicular to an incident surface 3a of the light guide plate 3 described later. The structure of the illuminator 2 will be described in detail later.

The light guide plate 3 is formed from a transparent resin material with a relatively high refractive index. The light guide plate 3 includes the incident surface 3a to receive light emitted from the illuminator 2, an emission surface 3b, or a front surface of the light guide plate 3, from which light is emitted, and a rear surface 3c opposite to the emission surface 3b.

The optical path deflector 4 is located on the rear surface 3c of the light guide plate 3. The optical path deflector 4 deflects guided light to be emitted through the emission surface 3b of the light guide plate 3. The optical path deflector 4 is, for example, a prism.

In the stereoscopic display 1, the light guide plate 3 receives parallel light emitted from the illuminator 2 and incident on the incident surface 3a of the light guide plate 3. The light entering the light guide plate 3 is guided through the interior of the light guide plate 3, deflected by the optical path deflector 4, and emitted through the emission surface 3b of the light guide plate 3. The light guide plate 3 forms (performs image formation), with the light emitted through the emission surface 3b, a stereoscopic image I (stereoscopic image) in a space as a real image or a virtual image. Image formation of the stereoscopic image I may use any known technique and will not be described in detail.

### Structure of Illuminator 2

The structure of the illuminator 2 will now be described with reference to FIGS. 2, 3, 4 and 5.

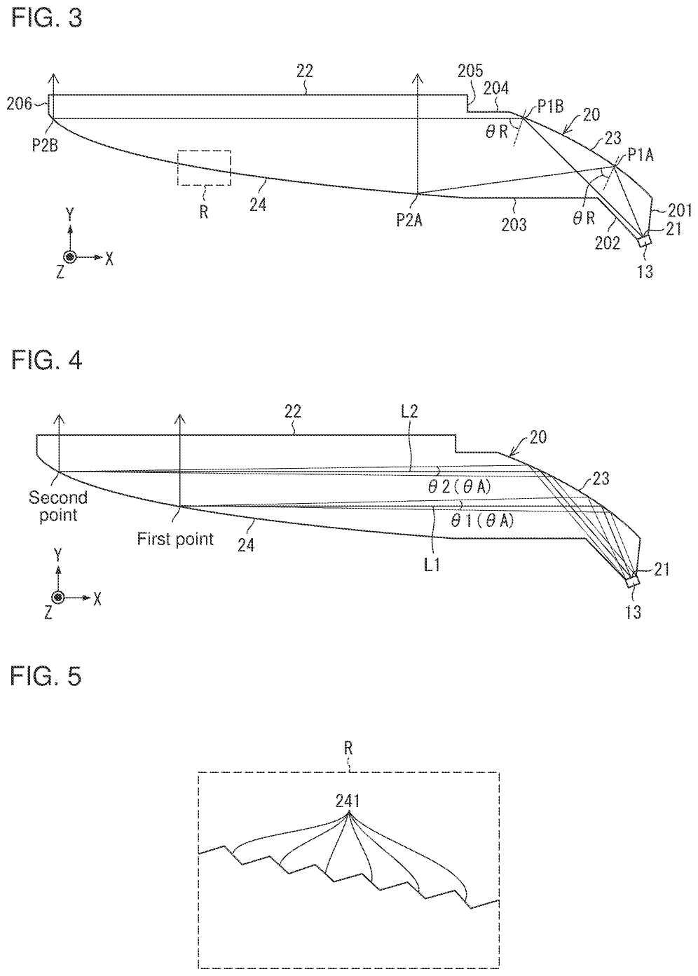

FIG. 2 is a perspective view of the illuminator 2. FIGS. 3 and 4 are cross-sectional views of a light guide 20 accommodated in the illuminator 2. FIGS. 3 and 4 additionally show a light source 13. FIG. 5 is an enlarged view of region R in FIG. 3. For ease of explanation, X-direction in FIG. 3 is hereafter referred to as a lateral direction, and Y-direction as a vertical direction. Also, the positive X-direction is referred to as a right direction, the negative X-direction as a left direction, the positive Y-direction as an upper direction, the negative Y-direction as a lower direction, the positive Z-direction as a front direction, and the negative Z-direction as a rear direction.

As shown in FIGS. 2, 3, and 4, the illuminator 2 includes a housing 11, the light guide 20, and the light source 13. The illuminator 2 also includes a substrate receiving the light source 13 (not shown).

The housing 11 accommodates the light source 13 and the light guide 20. The housing 11 is, for example, a substantially rectangular prism. The housing 11 has an opening 11a in a portion facing the incident surface 3a of the light guide plate 3.

The light source 13 causes light to enter the light guide 20. The light source 13 is, for example, a light-emitting diode (LED). The light source 13 may be a monochromatic LED, or a combination of three LEDs, respectively emitting red light, green light, and blue light. The light source 13 including the LEDs in three colors can emit variously colored light by controlling the light intensities of the respective LEDs. Accordingly, the color of the stereoscopic image I may be changed for its use.

The light guide 20 converts, in its interior, light emitted from the light source 13 into parallel light. The light guide 20 is formed from a resin material with a relatively high refractive index. The structure of the light guide 20 will now be described with reference to FIGS. 3, 4, and 5.

As shown in FIG. 3, the light guide 20 includes an incident surface 21, an emission surface 22, a first reflective surface 23, and a second reflective surface 24. The light guide 20 has a predetermined thickness in the front-rear direction. The light guide 20 may also have a first connection surface 201, a second connection surface 202, a third connection surface 203, a fourth connection surface 204, a fifth connection surface 205, and a sixth connection surface 206.

The incident surface 21 is a surface through which light emitted from the light source 13 enters the light guide 20. The incident surface 21 is flat. Light from the light source 13 forms a light flux in the incident surface 21. A cross section of the light flux taken along the incident surface 21 may have the shape of the light source 13 when the light source 13 is smaller than the incident surface 21. The cross section of the light flux may have the shape of the incident surface 21 when the light source 13 is larger than the incident surface 21.

The emission surface 22 is a surface through which light guided through the interior of the light guide 20 is emitted. The emission surface 22 is flat. Light emitted through the emission surface 22 travels to the incident surface 3a of the light guide plate 3 through the opening 11a in the housing 11.

The first reflective surface 23 (first deflection surface) reflects (deflects), to the second reflective surface 24, light emitted from the light source 13 and entering the light guide 20 through the incident surface 21. As shown in FIG. 3, the first reflective surface 23 has a reflection angle θR (deflection angle) at which light incident on the incident surface 21 is reflected by the first reflective surface 23. The reflection angle θR is nonuniform across the first reflective surface 23. Such a structure allows the first reflective surface 23 to reflect light to spread over the second reflective surface 24, which is larger than the first reflective surface 23.

For example, the first reflective surface 23 may be curved and depressed in a direction in which light is received through the incident surface 21. In other words, the cross section of the first reflective surface 23 parallel to the X-Y plane may be curved and depressed in a direction in which light is incident on the incident surface 21. The first reflective surface 23 including a first end and a second end may have the reflection angle θR, at which light is reflected by the first reflective surface 23, varying continuously from the first end to the second end. In other words, the curvature of the first reflective surface 23 on the cross section parallel to the X-Y plane may vary continuously from the first end to the second end of the first reflective surface 23. Accordingly, the curvature of the first reflective surface 23 may be greater in a portion near the light source 13 or may be greater in a portion far from the light source 13. Such a structure can reduce interference of light reflected at different points on the first reflective surface 23. In other words, the above described structure can reduce stray light. Accordingly, the degree of variation (rate of variation) in the reflection angle θR may vary from the first end to the second end of the first reflective surface 23. In other words, the degree of variation (rate of variation) in the curvature from the first end to the second end of the first reflective surface 23 may vary from the first end to the second end of the first reflective surface 23. The above described structure can control the intensity distribution of light emitted through the emission surface 22.

With the first reflective surface 23 viewed from the second reflective surface 24, the visual angle of an emission area in the incident surface 21 is θA (refer to FIG. 4). The emission area may be an emission surface of the light source 13. In other words, with the first reflective surface 23 viewed from any point on the second reflective surface 24 in the positive X-direction, the visual angle θA is a visual angle of a virtual image of the emission area in the incident surface 21 formed on the first reflective surface 23. The first reflective surface 23 may reflect light incident on the incident surface 21 to allow the visual angle θA when viewed from any point on the second reflective surface 24 to be substantially uniform. The visual angle θA can be controlled by, for example, varying the curvature of the first reflective surface 23. More specifically, the visual angle θA increases with the decrease in the curvature of the first reflective surface 23. The visual angle θA decreases with the increase in the curvature, which can improve uniformity in the intensity distribution of light emitted through the emission surface 22. To improve uniformity in the intensity distribution, the visual angle θA with variations in a range of 10% may be substantially uniform.

The first reflective surface 23 may totally internally reflect at least a portion of light incident on the incident surface 21. The amount of light totally internally reflected depends on, for example, an absolute refractive index of the light guide 20, and an angle at which light is incident on the first reflective surface 23. When a small amount of light is totally internally reflected, the first reflective surface 23 may have a reflection layer formed by, for example, metal vapor deposition. The reflection layer may be formed by a method other than metal vapor deposition, such as sputtering or coating.

The first reflective surface 23 may have a parabolic cross section parallel to the X-Y plane. Accordingly, the reflected light from the first reflective surface 23 can be parallel light with the light source 13 placed at the focal point of the parabolic cross section.

The second reflective surface 24 (second deflection surface) reflects (deflects) at least a portion of light reflected by the first reflective surface 23 to be parallel light. The overall second reflective surface 24 is depressed in the direction in which light reflected by the first reflective surface 23 enters the second reflective surface 24. As shown in FIG. 5, the second reflective surface 24 has a saw-toothed cross section parallel to the X-Y plane. For example, as shown in FIG. 5, the second reflective surface 24 has a stepped cross section parallel to the X-Y plane and may have discontinuous reflective surfaces 241 to reflect light reflected by the first reflective surface 23 to the emission surface 22 to be parallel light.

The second reflective surface 24 with the above structure can shorten the length of the light guide 20 perpendicular to the emission surface (vertical length).

The second reflective surface 24 may totally internally reflect at least a portion of light reflected by the first reflective surface 23. When a small amount of light is totally internally reflected, similarly to the first reflective surface 23, the second reflective surface 24 may have a reflection layer formed by, for example, metal vapor deposition.

The relationship between an optical path length to the second reflective surface 24 of the light guide 20 according to one or more embodiments and the visual angle θA will now be described with reference to FIG. 4. As shown in FIG. 4, the second reflective surface 24 includes, on its surface, a first point and a second point at each of which the second reflective surface intersects with an optical path of light incident on the incident surface 21, reflected by the first reflective surface, and reaching the second reflective surface. An optical path length L1 to the first point is shorter than an optical path length L2 to the second point.

When the first reflective surface 23 is viewed along the optical path from the first point, a visual angle θ1 is a visual angle θA of the cross section of the light flux incident on the incident surface 21 taken along the incident surface 21. When the first reflective surface 23 is viewed along the optical path from the second point, a visual angle θ2 is a visual angle θA of the cross section. Accordingly, the light guide 20 satisfies θ1×L1<θ2×L2. The above described structure can improve uniformity in the intensity distribution of light emitted through the emission surface.

The first reflective surface 23 includes a third point located in a direction aligned with an optical axis of the light source 13 (emission area) when viewed from the light source 13 (the center of the emission area in the incident surface 21) and a fourth point located in a direction tilted with respect to the optical axis of the light source 13 when viewed from the light source 13. The light source has a smaller apparent area at a point on the first reflective surface 23 away from (tilted with respect to) the optical axis. The first reflective surface 23 may have a greater curvature at the fourth point than at the third point, which can improve uniformity in the intensity distribution of light emitted through the emission surface. The optical axis of the light source 13 is, for example, perpendicular to the emission surface of the light source 13.

As shown in FIG. 3, in the light guide 20, a lower end of the first reflective surface 23 and a right end of the incident surface 21 may be connected to each other with the flat first connection surface 201 between them. A lower end of the second reflective surface 24 may have the same x-coordinate as a right end of the emission surface 22, and the same y-coordinate as a lower end of the first reflective surface 23. The lower end of the second reflective surface 24 may be connected to a left end of the flat third connection surface 203 parallel to the emission surface 22. A right end of the third connection surface 203 may be connected to a left end of the flat second connection surface 202 connected to a left end of the incident surface 21. A right end of the second connection surface 202 may be connected to the left end of the incident surface 21. A left end of the emission surface 22 and an upper end of the second reflective surface 24 may be connected to each other with the flat sixth connection surface 206 perpendicular to the emission surface 22 between them. An upper end of the first reflective surface 23 may have the same y-coordinate as an upper end of the second reflective surface 24 and may be connected to a first end of the flat fourth connection surface 204 parallel to the emission surface 22. A second end of the fourth connection surface 204 may be connected to the flat fifth connection surface 205 connected to the right end of the emission surface 22 and perpendicular to the emission surface 22.

The positions of the ends of the first reflective surface 23 and the second reflective surface 24 are not limited to the positions described in the above embodiment. The shapes of the connection surfaces connecting the incident surface 21, the first reflective surface 23, the second reflective surface 24, and the emission surface 22 and the angles between the connection surfaces and the incident surface 21, the first reflective surface 23, the second reflective surface 24, and the emission surface 22 may be appropriately modified in accordance with the incident surface 21, the first reflective surface 23, the second reflective surface 24, and the emission surface 22.

The light guide plate 3 may be integral with the light guide 20.

### Second Embodiment

Another embodiment or embodiments will now be described. For ease of explanation, the components having the same functions as the components described in the above embodiment are given the same reference numerals as those components and will not be described repeatedly. The same applies to other embodiments described later.

### Structure of Light Guide 20A

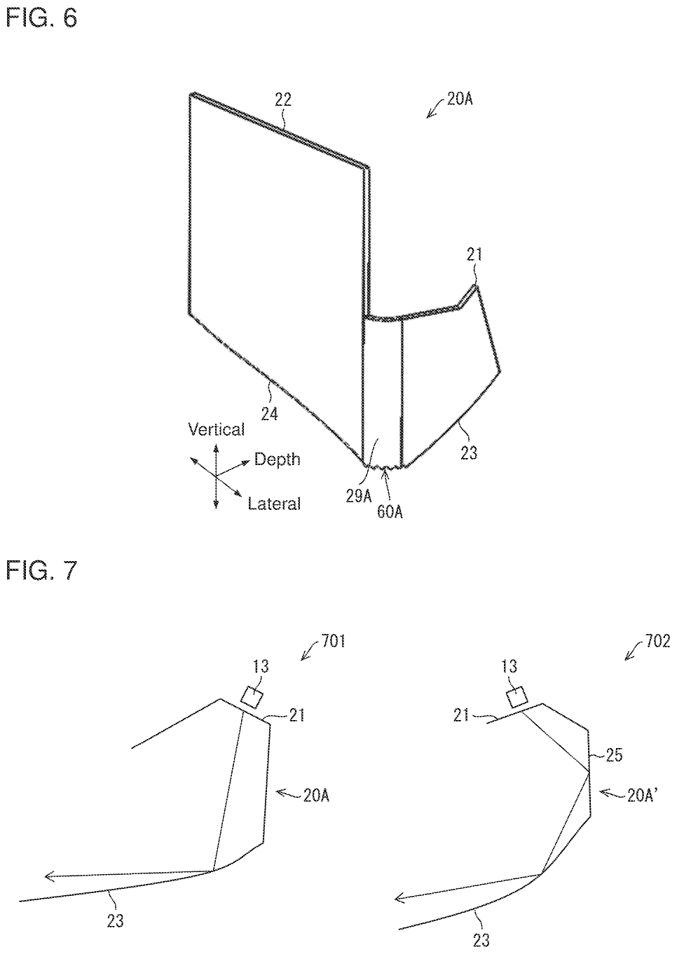

FIG. 6 is a perspective view of a light guide 20A according to another embodiment or embodiments. The light guide 20A includes a bend 29A, differently from the light guide 20 of the first embodiment. The bend 29A is located between the first reflective surface 23 and the second reflective surface 24. As shown in FIG. 6, the bend 29A has at least a portion of a surface connecting the first reflective surface 23 and the second reflective surface 24 with a notch area 60A including multiple notches to release stray light away.

The light guide 20A including the bend 29A can have a shorter lateral length.

FIG. 7 is a schematic diagram of the light guide 20A and a light guide 20A′ as a modification of the light guide 20A, each showing a portion near the incident surface 21. FIG. 7 includes a schematic diagram of the light guide 20A as indicated by reference numeral 701, and a schematic diagram of the light guide 20A′ as indicated by reference numeral 702. The light guide 20A′ with reference numeral 702 in FIG. 7 includes a third reflective surface 25 between the incident surface 21 and the first reflective surface 23 to reflect the light incident on the incident surface 21 toward the first reflective surface 23. The light guide 20A′ including the third reflective surface 25 can have a shorter length in the depth direction shown in FIG. 6.

### Third Embodiment

### Structure of Light Guide 20B

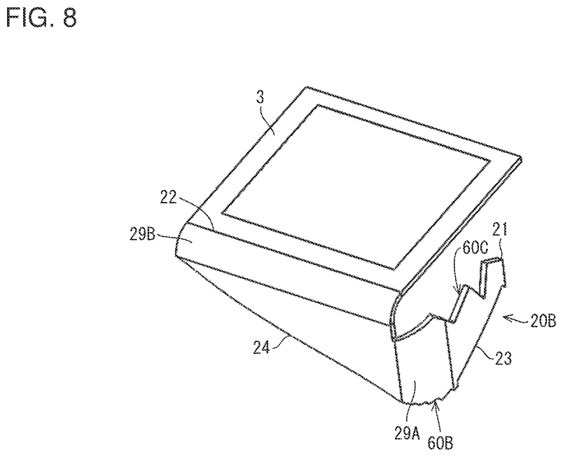

FIG. 8 is a perspective view of a light guide 20B according to still another embodiment or embodiments. For better understanding, FIG. 8 additionally shows the light guide plate 3. The light guide 20B includes the bend 29A and a bend 29B, differently from the light guide 20 according to the first embodiment. The bend 29B is between the second reflective surface 24 and the emission surface 22. As shown in FIG. 7, at least a portion of a surface connecting the emission surface 22 and the incident surface 21 may have a notch area 60C including multiple notches to release stray light away.

The light guide 20B including the bend 29A and the bend 29B can be near the side surface or the rear surface of the light guide plate 3.

One or more embodiments described herein should not be construed to be restrictive, but may be modified within the spirit and scope of the claimed invention. The technical features described in different embodiments may be combined in other embodiments within the technical scope.

1. A light guide, comprising:
an incident surface configured to receive light from a light source;
a first deflection surface configured to deflect light incident on the incident surface; and
a second deflection surface configured to deflect at least a portion of light deflected by the first deflection surface to be parallel light, wherein
the first deflection surface deflects light incident on the incident surface at a deflection angle nonuniform across the first deflection surface, and
the second deflection surface has a saw-toothed cross section.

2. The light guide according to claim 1, wherein
the first deflection surface is curved, and
the deflection angle varies continuously from a first end to a second end of the first deflection surface.

3. The light guide according to claim 2, wherein
the first deflection surface has a degree of variation in the deflection angle varying from the first end to the second end.

4. The light guide according to claim 1, wherein
the second deflection surface includes a first point and a second point, the first point is an intersection between the second deflection surface and an optical path of light incident on the incident surface, deflected by the first deflection surface, and reaching the second deflection surface, and the second point is an intersection between the second deflection surface and an optical path of light incident on the incident surface, deflected by the first deflection surface, and reaching the second deflection surface,
the optical path of light from the incident surface to the first point is shorter than the optical path of light from the incident surface to the second point, and
the light guide satisfies the expression:
θ1×L1<θ2×L2,
where L1 is a length of the optical path of light from the incident surface to the first point, L2 is a length of the optical path of light from the incident surface to the second point, θ1 is a visual angle of an emission area in the incident surface when the first deflection surface is viewed along the optical path from the first point, and θ2 is a visual angle of the cross section when the first deflection surface is viewed from the second point.

5. The light guide according to claim 4, wherein
a value of an expression θ×L increases with an increase in the length of the optical path of the light from the incident surface to a point on the second deflection surface, where θ is a visual angle of the emission area when the first deflection surface is viewed from the point on the second deflection surface, and L is a length of the optical path from the incident surface to the point.

6. The light guide according to claim 1, wherein
the first deflection surface deflects light incident on the incident surface to allow θA to be substantially uniform at a point on the second deflection surface, where θA is a visual angle of an emission area in the incident surface when the first deflection surface is viewed from the second deflection surface.

7. The light guide according to claim 1, wherein
the first deflection surface includes a third point located in a direction aligned with an optical axis of light incident on the incident surface when viewed from an emission area in the incident surface, and a fourth point located in a direction tilted with respect to the optical axis when viewed from the emission area, and
the first deflection surface has a greater curvature at the fourth point than at the third point.

8. The light guide according to claim 1, wherein
the first deflection surface reflects light incident on the incident surface, and
the deflection angle is a reflection angle at which light incident on the incident surface is reflected by the first deflection surface.

9. The light guide according to claim 8, wherein
the first deflection surface totally internally reflects at least a portion of light incident on the incident surface.

10. The light guide according to claim 1, wherein
the second deflection surface reflects at least a portion of light deflected by the first deflection surface to be parallel light.

11. The light guide according to claim 10, wherein
the second deflection surface totally internally reflects at least a portion of light deflected by the first deflection surface to be parallel light.

12. An illuminator, comprising:
the light guide according to claim 1; and
the light source.

13. A stereoscopic display, comprising:
the illuminator according to claim 12; and
a light guide plate configured to receive parallel light emitted through the second deflection surface and form a stereoscopic image in a space as a real image or a virtual image.

14. A stereoscopic display, comprising:
the illuminator according to claim 12; and
a light guide plate integral with the light guide to receive parallel light emitted through the second deflection surface and form a stereoscopic image in a space as a real image or a virtual image.

15. The light guide according to claim 2, wherein
the second deflection surface includes a first point and a second point, the first point is an intersection between the second deflection surface and an optical path of light incident on the incident surface, deflected by the first deflection surface, and reaching the second deflection surface, and the second point is an intersection between the second deflection surface and an optical path of light incident on the incident surface, deflected by the first deflection surface, and reaching the second deflection surface,
the optical path of light from the incident surface to the first point is shorter than the optical path of light from the incident surface to the second point, and
the light guide satisfies the expression:
θ1×L1<θ2×L2,
where L1 is a length of the optical path of light from the incident surface to the first point, L2 is a length of the optical path of light from the incident surface to the second point, θ1 is a visual angle of an emission area in the incident surface when the first deflection surface is viewed along the optical path from the first point, and θ2 is a visual angle of the cross section when the first deflection surface is viewed from the second point.

16. The light guide according to claim 3, wherein
the second deflection surface includes a first point and a second point, the first point is an intersection between the second deflection surface and an optical path of light incident on the incident surface, deflected by the first deflection surface, and reaching the second deflection surface, and the second point is an intersection between the second deflection surface and an optical path of light incident on the incident surface, deflected by the first deflection surface, and reaching the second deflection surface,
the optical path of light from the incident surface to the first point is shorter than the optical path of light from the incident surface to the second point, and
the light guide satisfies the expression:
θ1×L1<θ2×L2,
where L1 is a length of the optical path of light from the incident surface to the first point, L2 is a length of the optical path of light from the incident surface to the second point, θ1 is a visual angle of an emission area in the incident surface when the first deflection surface is viewed along the optical path from the first point, and θ2 is a visual angle of the cross section when the first deflection surface is viewed from the second point.

17. The light guide according to claim 2, wherein
the first deflection surface deflects light incident on the incident surface to allow θA to be substantially uniform at a point on the second deflection surface, where θA is a visual angle of an emission area in the incident surface when the first deflection surface is viewed from the second deflection surface.

18. The light guide according to claim 3, wherein
the first deflection surface deflects light incident on the incident surface to allow θA to be substantially uniform at a point on the second deflection surface, where θA is a visual angle of an emission area in the incident surface when the first deflection surface is viewed from the second deflection surface.

19. The light guide according to claim 4, wherein
the first deflection surface deflects light incident on the incident surface to allow θA to be substantially uniform at a point on the second deflection surface, where θA is a visual angle of an emission area in the incident surface when the first deflection surface is viewed from the second deflection surface.

20. The light guide according to claim 5, wherein
the first deflection surface deflects light incident on the incident surface to allow θA to be substantially uniform at a point on the second deflection surface, where θA is a visual angle of an emission area in the incident surface when the first deflection surface is viewed from the second deflection surface.
